(19) United States
(12) Patent Application Publication
(10) Pub. No.: US 2026/0284963 A1
(43) Pub. Date: Sep. 24, 2026

(54) ADDITIVE MANUFACTURING OF THREE-DIMENSIONAL SOLID PARTS BY SELF-PROPAGATING CURING REACTIONS

(71) Applicant: The Board of Trustees of the University of Illinois, Urbana, IL (US)

(72) Inventors: Sameh H. TAWFICK, Champaign, IL (US); Jeffrey S. MOORE, Savoy, IL (US); Philippe H. GEUBELLE, Champaign, IL (US); Nancy R. SOTTOS, Champaign, IL (US); Jacob J. LESSARD, Champaign, IL (US); Yun Seong KIM, Champaign, IL (US); Minjiang ZHU, Urbana, IL (US); Randy H. EWOLDT, Urbana, IL (US); Mohammad Tanver HOSSAIN, Urbana, IL (US)

(21) Appl. No.: 19/476,069

(22) PCT Filed: Apr. 17, 2024
(86) PCT No.: PCT/US2024/024995

§ 371 Date: Oct. 16, 2025

Related U.S. Application Data
(60) Provisional application No. 63/496,922, filed on Apr. 18, 2023.

(51) Int. Cl. B29C 64/124; B29C 64/245; B29C 64/393; B33Y 10/00; B33Y 50/02

(52) U.S. Cl. CPC B29C 64/124; B29C 64/245; B29C 64/393; B33Y 10/00; B33Y 50/02

(57) ABSTRACT

A growth printing method for manufacturing a three-dimensional (3D) part comprises triggering a frontal polymerization reaction by contacting an uncured liquid with an initiator. After the frontal polymerization reaction is triggered, the initiator is moved in at least one of x-, y- and z-directions to control a shape of a 3D part additively formed as the uncured liquid is polymerized. In another implementation, the method comprises utilizing computer simulations to predict the motion of an initiator required to additively form a 3D part having a targeted shape during frontal polymerization. The method further includes triggering a frontal polymerization reaction by contacting an uncured liquid with the initiator. After the reaction is triggered, the initiator is moved as predicted by the computer simulations to additively form, as the uncured liquid is polymerized, the 3D part having the targeted shape.

### RELATED APPLICATION

The present patent document claims the benefit of priority under 35 U.S.C. 119 (e) to U.S. Provisional Patent Application No. 63/496,922, which was filed on Apr. 18, 2023, and is hereby incorporated by reference in its entirety.

### STATEMENT REGARDING FEDERALLY SPONSORED RESEARCH OR DEVELOPMENT

This invention was made with government support under DE-SC0023457 awarded by the Department of Energy. The United States Government has certain rights in the invention.

### TECHNICAL FIELD

This present disclosure is directed generally to additive manufacturing of three-dimensional solid parts, and more particularly to growth printing.

### BACKGROUND

Polymerization is a chemical reaction in which monomers are linked together to form polymers. Polymers include large molecules, or macromolecules, that are made up of monomeric subunits, or monomers. Products such as plastic bottles, rubber tires, and textiles rely on polymer technology.

Frontal ring-opening metathesis polymerization (FROMP), also referred to as frontal polymerization, is a technique for rapid and energy-efficient manufacturing of polymeric materials and involves propagation of a localized curing front. This versatile polymerization technique can be used to produce a wide variety of polymers. The method is particularly well-suited for the production of high-performance polymers, such as those used in aerospace and electronics applications.

### BRIEF DESCRIPTION OF THE DRAWINGS

FIGS. 1A-1G are schematics showing an example of the growth printing process.

FIG. 2 shows initiator tip velocity as a function of time for the growth printing process illustrated in FIGS. 1A-1G,

FIGS. 3A-3C show schematics of actual 3D parts formed by growth printing for velocity ratios (ũ=uₜᵢₚ/u_{f}) greater than 1, less than 1, and approximately equal to 1, where uₜᵢₚ is the velocity of the initiator tip and us is the velocity of the curing front.

FIGS. 4A-4G show schematics of actual 3D parts formed by growth printing at different velocity ratios, from ũ=0.56 to ũ=1.89.

FIG. 5A show a corrugated shape fabricated utilizing the growth printing approach illustrated in FIG. 5B and the velocity ratio versus time profile shown in FIG. 5C.

FIG. 6 shows a plot of cone angle (ϑ) versus velocity ratio (ũ),

FIG. 7 is a plot of maximum diameter for a growth-printed 3D part versus dwell time,

FIGS. 8A and 8B show schematics of an exemplary growth printing process with a highly viscous resin having extensional viscosity.

FIGS. 9A-9C show schematics of an exemplary growth printing process with a highly viscous resin, where the curing front is pulled above the level of the free surface of the uncured resin.

FIGS. 9D-9F show schematics of an exemplary growth printing process with a lower viscosity resin, where the curing front remains below the level of the free surface of the uncured resin.

FIGS. 10A-10C show growth printing of a curved object by rotation of the initiator with respect to an initial vertical position.

FIGS. 11A-11C show a cross-sectional view of an exemplary initiator tip with a circular profile, a view of an initial (top) cross-section of the 3D shape shortly after triggering of the polymerization front, and a view of a final (bottom) cross-section of the 3D shape, respectively. In this example, the 3D shape comprises polydicyclopentadiene (pDCPD).

FIGS. 12A-12C show a cross-sectional view of an exemplary initiator tip with a square profile, a view of an initial (top) cross-section of the 3D shape shortly after triggering of the polymerization front, and a view of a final (bottom) cross-section of the 3D shape, respectively.

FIGS. 13A-13C show a cross-sectional view of an exemplary initiator tip with a triangular profile, a view of an initial (top) cross-section of the 3D shape shortly after triggering of the polymerization front, and a view of a final (bottom) cross-section of the 3D shape, respectively, where regions of slow and faster frontal polymerization (FP) are indicated.

FIG. 14 shows, for two initiators having a spacing s in the uncured liquid, possible part geometries depending on the value of s and the velocity ratio ũ.

FIG. 15 illustrates the axisymmetric simulation problem, where an axis system is attached to the heated initiator tip and the free surface of the uncured liquid is progressively raised or lowered to capture the relative motion of the initiator tip.

FIGS. 16A-16D show comparisons between actual printed objects and the simulated objects for different velocity ratios.

FIGS. 17A-17E show a comparison of the growth profile over time of a simulated object versus the same object experimentally printed.

FIGS. 18A-18D show, respectively, an image of a pinecone and the associated NURBS curve, the predicted motion (displacement and speed) of the heated initiator tip, an image of the actual printed part based on the G-code, and a comparison between the growth-printed part and the original target shape.

FIGS. 19A-19D show, respectively, an image of a mini pumpkin and the associated NURBS curve, the predicted motion (displacement and speed) of the heated initiator tip, an image of the actual printed part based on the G-code, and a comparison between the growth-printed part and the original target shape.

FIGS. 20A-20D show, respectively, an image of a raspberry and the associated NURBS curve, the predicted motion (displacement and speed) of the heated initiator tip, an image of the actual printed part based on the G-code, and a comparison between the growth-printed part and the original target shape.

FIGS. 21A-21D show, respectively, an image of an acorn and the associated NURBS curve, the predicted motion (displacement and speed) of the heated initiator tip, an image of the actual printed part based on the G-code, and a comparison between the growth-printed part and the original target shape.

FIG. 22 shows storage modulus G′, loss modulus G″, and temperature measurements made via shear rheology before and after frontal polymerization of an exemplary liquid resin (DCPD).

While the present invention is susceptible to various modifications and alternative forms, exemplary embodiments thereof are shown by way of example in the drawings and are herein described in detail. It should be understood, however, that the description of exemplary embodiments is not intended to limit the invention to the particular forms disclosed, but on the contrary, the intention is to cover all modifications, equivalents and alternatives falling within the spirit and scope of the disclosure.

The patent or application file contains at least one drawing executed in color. Copies of this patent or patent application publication with color drawing(s) will be provided by the Office upon request and payment of the necessary fee.

### DETAILED DESCRIPTION

The technology now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Although specific terms are employed herein, they are used in a generic and descriptive sense only and not for purposes of limitation. Unless defined otherwise, all technical and scientific terms used herein have the same meaning as commonly understood by one of skill in the art to which the invention pertains.

Throughout the specification and claims, terms may have nuanced meanings suggested or implied in context beyond an explicitly stated meaning. Likewise, the phrase “in one embodiment” or “in one implementation” as used herein does not necessarily refer to the same embodiment or implementation and the phrase “in another embodiment” or “in another implementation” as used herein does not necessarily refer to a different embodiment or implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

Described in this disclosure is an additive manufacturing method and system to produce three-dimensional (3D) parts from frontally polymerizable resins. Compared to other additive manufacturing approaches, the present method may be faster, simpler to implement, and more energy-efficient. The method utilizes frontal polymerization chemistry, where a sharp curing front transforms a liquid resin (or “uncured liquid”) to a solid polymer as it propagates within the liquid resin. The spatial manipulation in one or more directions—e.g., in a z-direction out of the liquid resin—may guide the propagation of the curing front and create a desired 3D part geometry. In this disclosure the new additive manufacturing method may be referred to as “growth printing.”

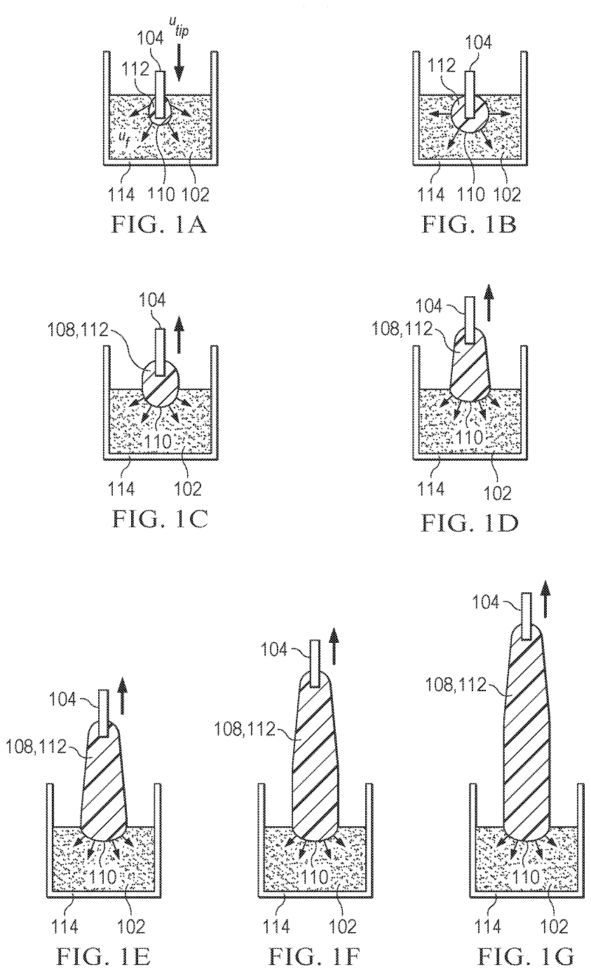

Referring to FIGS. 1A-1G, the method for manufacturing a three-dimensional (3D) part includes triggering a frontal polymerization reaction by contacting an uncured liquid 102 with an initiator 104, and, after the frontal polymerization reaction is triggered, moving the initiator 104 in at least one of x-, y- and z-directions 106 to control a shape of the 3D part 108 that is additively formed as the uncured liquid 102 undergoes polymerization. The exemplary schematics illustrate motion of the initiator 104 in the z-direction.

Upon triggering the frontal polymerization reaction, a self-propagating or self-energized curing front 110 is generated in the uncured liquid 102. The uncured liquid 102 may be understood to comprise a monomer solution including one or more frontally polymerizable monomers, such as dicyclopentadiene (DCPD), as discussed below. As illustrated in FIGS. 1A-1G, the initiator 104 may take the form of a solid object such as an elongated rod. Typically, the frontal polymerization reaction is triggered by supplying heat to the initiator 104, preferably a tip of the initiator 104, until a temperature (e.g., typically 70-90° C.) sufficient to trigger the reaction is reached. Also or alternatively, the frontal polymerization reaction may be triggered by one or more chemicals (e.g., a reaction catalyst), light (e.g., ultraviolet light), and/or electric current. Once the frontal polymerization reaction is triggered, no additional energy input may be required since the curing front is self-propagating.

Polymerization occurs as the curing front 110 propagates through the uncured liquid 102 in a direction away from the initiator 104, such that a 3D polymeric part 108 is additively formed from the liquid monomer(s). More specifically, energy from the exothermic polymerization reaction continuously transforms the one or more liquid monomers to a solid polymer 112 as the curing front propagates. The curing front 110 may delineate a fairly sharp transition between the uncured liquid 102 ahead of the front and the solid polymer 112 behind the front; in some examples, the curing front may span a width of about 1 mm. As the curing front propagates, the uncured liquid may transition from a Newtonian liquid with a low viscosity (e.g., 4.9 mPa·s at 25° C. for DCPD) to a viscoelastic solid polymer having, in the example of polyDCPD, a storage modulus of 2 GPa. In some examples, higher viscosity uncured liquids may be used for frontal polymerization, as discussed below.

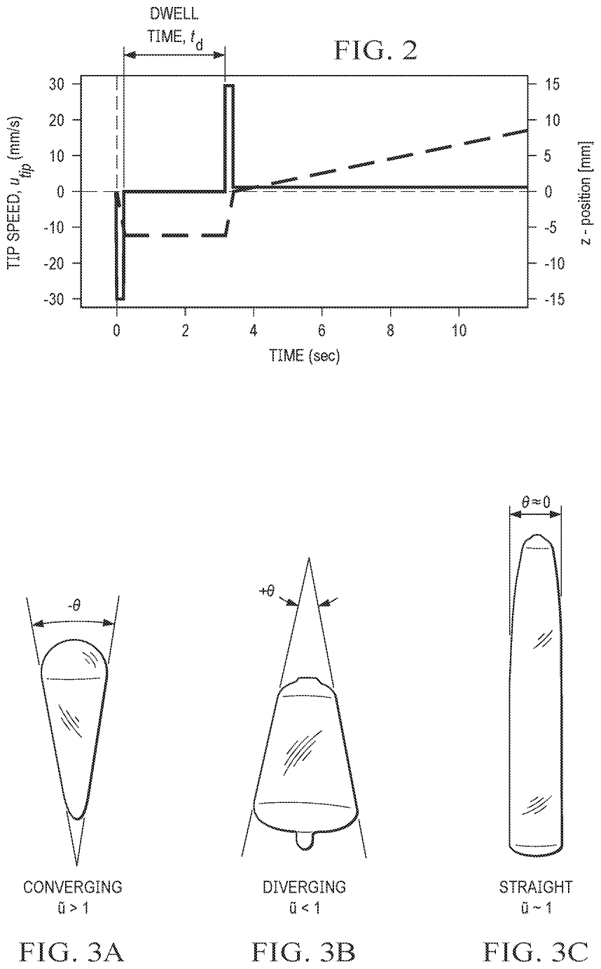

As illustrated in FIGS. 1A-1G, the uncured liquid 102 may be held within a container 114. The initiator 104 may contact the uncured liquid 102 from an open side of the container 114, which is usually the top side. The initiator 104 triggers the frontal polymerization reaction as described above, such that the reaction or curing front 110 propagates away from the initiator 104 into the liquid resin 102, transforming the liquid resin 102 to solid polymer 112 as it propagates. If the initiator 104 is spatially static (held without motion in the x-, y-, and/or z-directions) as in FIGS. 1A and 1B, the curing front 110 can propagate all directions where the uncured liquid 102 is present, forming, in some examples, a spherical or semi-spherical object. If the initiator 104 remains static (which is not the case with growth printing), the polymerization reaction can eventually solidify all of the liquid resin 102 to make one part having the same shape as the container 114. If the initiator 104 starts moving in a linear direction away from the container 114, for example upwards, as in FIG. 1C, the solid polymer 112 can be pulled out of the liquid resin 102 as it adheres to the initiator 104, while the curing front 110 continues to propagate. The 3D part 108 grows in a way that depends on the interplay between the motion of the curing front 110 and the motion of the initiator 104, as illustrated in FIGS. 1D-1G. Because the 3D part 108 grows additively by propagation of the curing front 110 during part manipulation, this method may be described as growth printing. The velocity of the initiator (more specifically, the initiator tip) and the position of the initiator (initiator tip) along the z-direction are plotted versus time in FIG. 2 for the growth printing process illustrated in FIGS. 1A-1G.

Importantly, by controlling the movement and velocity of the initiator 104, the size and shape of the additively manufactured 3D part can be controlled. It is noted that the movement of the initiator 104 is relative to the uncured liquid 102. Accordingly, either the initiator 104 may be physically moved upward (away from the uncured liquid 102) or the container 114 holding the uncured liquid 102 may be physically moved downward (away from the initiator 104), or both the initiator 104 and the container 114 may be simultaneously moved to effect the relative motion. In this disclosure, descriptions of the motion of the initiator 104 are understood to encompass the motion of either or both the initiator 104 and the container 114 holding the uncured liquid 102.

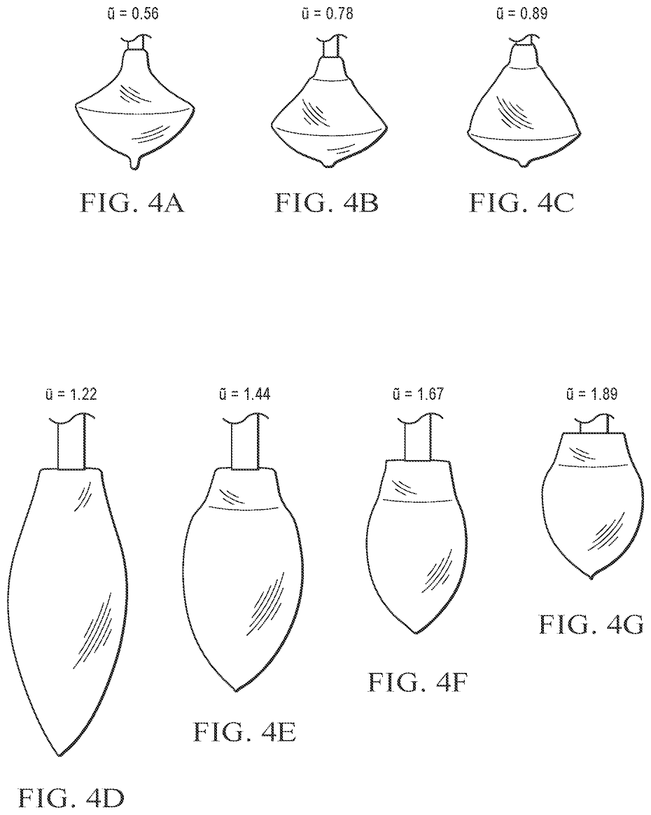

By modulating or controlling the velocity of the moving initiator, it is possible to significantly alter the shape of the resulting 3D part. The velocity of the initiator may be varied continuously and/or in a step-wise fashion during part or all of the growth printing process. In one example, the velocity (uₜᵢₚ) of the initiator may be controlled to be higher than a velocity (u_{f}) of the curing front, such that a ratio ũ=uₜᵢₚ/u_{f} is greater than 1. In this situation, the shape of the part converges as the initiator moves, and the final 3D part may have a shape like an inverted cone with the base on the top, as shown in FIG. 3A. In another example, the velocity of the initiator may be controlled to be lower than the velocity of the curing front, such that the ratio ũ is less than 1. In this situation, the shape of the part diverges as the initiator moves, and the final 3D part may have a shape like a cone with the base at the bottom, as shown in FIG. 3B. In another example, the velocity of the initiator may be controlled to be about the same as the velocity of the curing front, such that the ratio @ is approximately equal to 1. In this situation, the shape of the part maintains its lateral extent, and a continuous cylinder or other elongated shape with substantially parallel sides may be produced with a length equal to the translation distance of the initiator. Images of actual 3D parts produced by growth printing using velocity ratios ũ ranging from about 0.6 to about 1.9 (more specifically, ũ=0.56, 0.78, 0.89, 1.22, 1.44, 1.67, and 1.89) are shown in FIGS. 4A-4G, respectively.

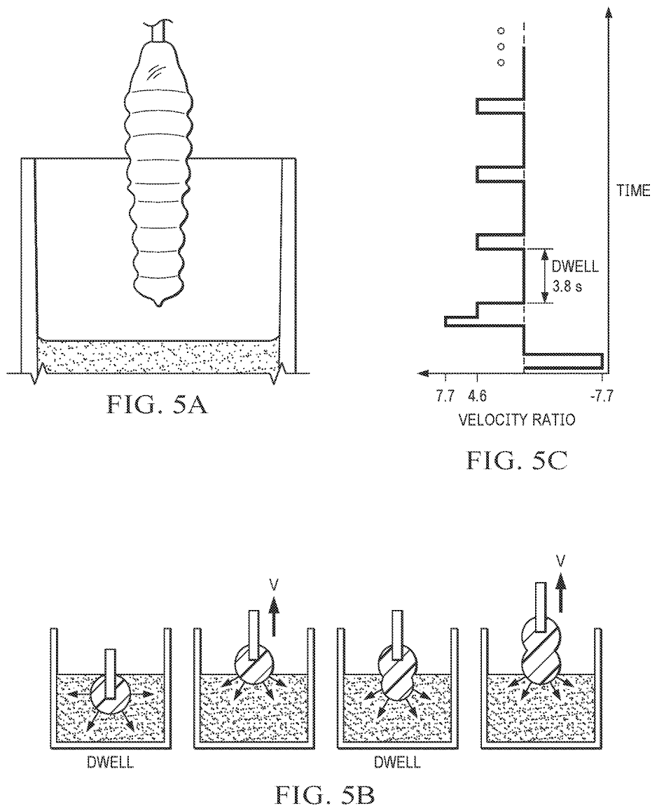

In order to produce a 3D part having a complex shape, the velocity of the initiator may be controlled to be higher than, lower than, and/or approximately the same as the velocity of the curing front at different times during the growth printing process. For example, corrugations may be introduced by an intermittent upward motion of the tip (e.g., with starts and stops (“dwells”) or an alternately increasing and decreasing velocity) during the initiator's upward motion, such that the 3D part has a corrugated profile, as shown for example in FIG. 5A. The associated motion of the initiator is shown in the schematics of FIG. 5B and in the plot of velocity ratio ũ versus time (FIG. 5C).

Contacting the uncured liquid with the initiator may entail introducing or lowering the initiator into the uncured liquid such that a tip of the initiator is at least 2 mm below a surface of the uncured liquid. Typically, the initiator triggers frontal polymerization by heat (e.g., by supplying an electric current to the initiator until it reaches a sufficient temperature to trigger the reaction). Prior to introduction of the initiator into the uncured liquid, the initiator may be positioned above the surface of the liquid by a distance >5 mm; that is, the lowest point of the initiator, or the tip, may be positioned above the surface by about 5 mm or more. This distance may ensure that the heat from the initiator does not trigger the curing before the initiator contacts the liquid. In some examples, after frontal polymerization is triggered and prior to moving the initiator, the initiator may be held stationary for a predetermined dwell time as the polymerization front propagates away from the initiator; a larger dwell time allows for the curing front to propagate further away from the initiator tip before the initiator moves, and thus may be used to produce a larger or wider part. Once the initiator begins to move after frontal polymerization has been triggered, it may be withdrawn from the uncured liquid in an initial fairly rapid motion.

Referring to the initiator (tip) motion profile of FIG. 2, which corresponds to the growth printing process illustrated in FIG. 1, the following steps can be observed: (1) immersion of the tip (downward motion of the initiator), (2) dwell, (3) withdrawal of the tip (fast upward motion of the initiator), and (4) upward motion at a different velocity. The immersion step typically involves a 5 mm downward motion (along the z direction) at, in this example, 30 mm/s, which is the maximum speed of the motion stage, and the withdrawal step may be a 5 mm upward motion at the same speed. The dwell time is the holding step in between steps 1 and 3 to control the size of the printed part. As discussed above, the part geometry depends on the ratio ũ of the initiator tip velocity to the curing front velocity. If the initiator tip moves slower than the curing front (ũ<1), the front continuously grows to a larger lateral size, forming a diverging shape. If the tip moves faster than the curing front (ũ>1), the growing part converges to a point. If the two are nearly the same (ũ≈1) then the curing front maintains its lateral extent, producing a straight shape with substantially parallel sides.

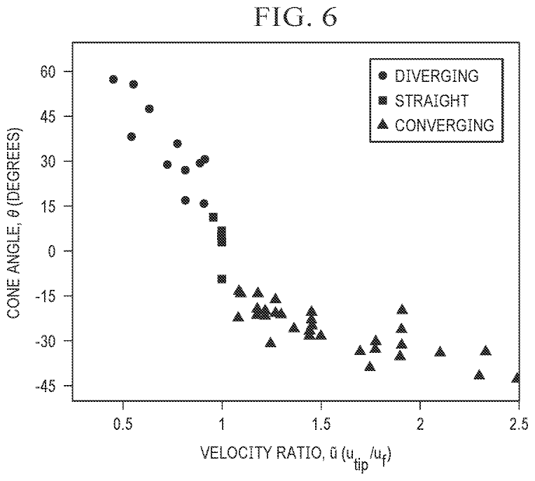

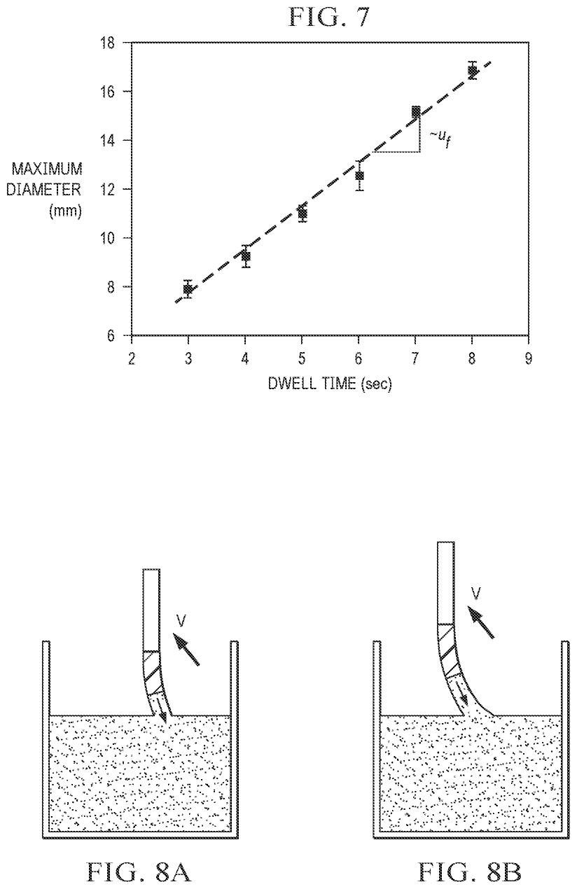

Accordingly, the shapes of the printed parts may be categorized by what is referred to as a cone angle ϑ. A negative cone angle indicates a converging shape (FIG. 3A) a positive cone angle, +ϑ indicates a diverging shape (FIG. 3B), and a nearly zero cone angle indicates a straight shape (FIG. 3C). The dependence of ϑ on ü is plotted in FIG. 6. The effect of the dwell time on the lateral size of the 3D part is shown in FIG. 7. During the dwell time, the initiator tip holds its position and allows the polymerization front to propagate freely in the resin bath, forming an initial shape (e.g., a spherical shape) that may define the lateral extent of the 3D part.

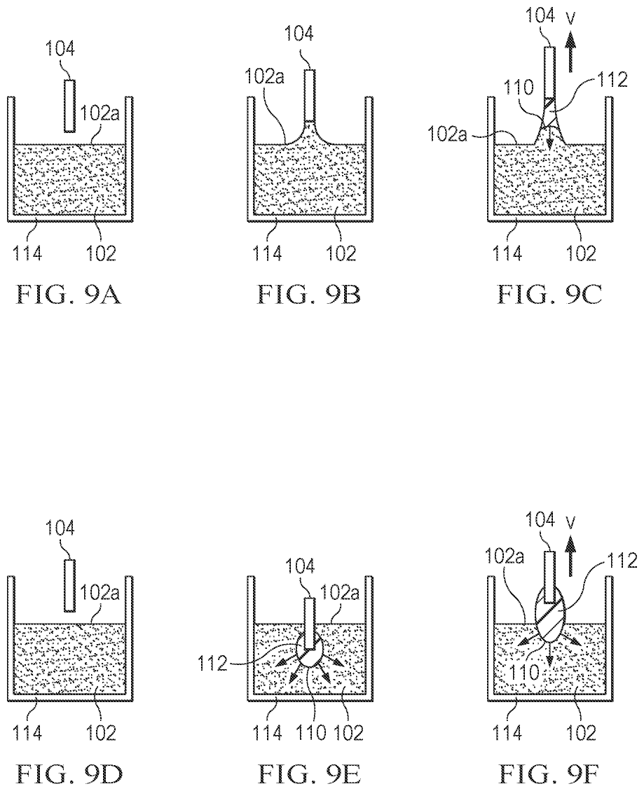

Another variation of the process uses the ability of the liquid resin at higher viscosities to form continuous filaments when the initiator is withdrawn from the reservoir, as shown in FIGS. 8A and 8B. The liquid resin in these examples can be altered by adding additives or increasing the degree of cure to achieve a zero-shear viscosity above about 1000 cP (1 Pa·s) at room temperature, which is typically around 18-23° C. These modifications may enable the resin to form continuous stable filaments when the initiator is withdrawn from the reservoir by resisting capillary breakup until the curing front solidifies the filament. Organic and/or inorganic additives, such as polyethylene glycol or silica, may be used to increase the viscosity of the resin to enable this extensional viscosity. The combination of the additives and the degree of cure may adjust the resin's properties to be non-Newtonian, thereby increasing its extensional viscosity during the drawing process. Referring to FIGS. 8A and 8B, a stable, partially cured filament 118 may be formed between the initiator 104 on the top and the uncured resin 102 on the bottom. The initiator 104 may be moved in the x-, y- and/or z-directions, causing the filament 118 to bend and twist with the initiator 104, ultimately forming a helix or zigzag shaped part, for example. Bending the filament may lead to the formation of complex 3D parts as the curing front is propagates in the filament. With high viscosity liquid resins, the self-propagating curing front 110 may be drawn at or above a level of a free surface 102a of the uncured liquid 102 during the motion of the initiator 104, as can be seen in FIGS. 9A-9C. In contrast, referring to FIGS. 9D-9F, when the uncured liquid 102 has a lower, liquid-like viscosity (e.g., less than 1000 cP (1 Pa·s), and typically about 100 cP (0.1 Pa·s) or less at room temperature (e.g., 18-23° C.)), the self-propagating curing front 110 remains below the level of a free surface 102a of the uncured liquid 102 during motion of the initiator 104, such that a solidified polymer 112 (not a liquid filament) is withdrawn from the container 114 as the initiator 104 is moved upward.

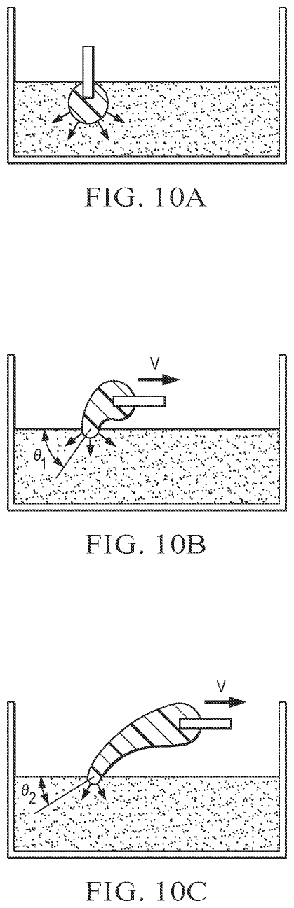

In addition to the axisymmetric parts described above, the process may be used to produce non-axisymmetric 3D parts, such as curved shapes, by adding rotations to the initiator tip during its motion, as illustrated in FIGS. 10A-10C. To make a curved shape, the initiator tip may be rotated or tilted at an angle with respect to the z-direction during the growth printing process. Without this rotation, the produced part may remain axisymmetric as the initiator moves upwards. When rotational motion is superimposed on (that is, combined with) the vertical upward motion, the growth direction may be tilted with respect to the initiator; as a result, the part produced instantaneously after the tilt has a curvature near the liquid interface, represented by angles ϑ₁ and ϑ₂ in FIGS. 10B and 10C. If the tilt angle gradually increases, the part continues to extend in a curved geometry. By controlling the initiator velocity in the vertical, horizontal, and angular tilt directions, various curved part geometries may be obtained.

As indicated above, the liquid resin (or “uncured liquid”) may include one or more frontally polymerizable monomers and optionally other additive(s). Accordingly, the uncured liquid may be referred to as a monomer solution. Examples of frontally polymerizable monomers include dicyclopentadiene (DCPD), including the endothermic and exothermic versions of DCPD, 1,5-cyclooctadiene (COD), benzocyclobutene, norbornene (NBE), 5-ethylidene-2-norbornene, functionalized norbornenes which includes fragrant resins like NBE-acetate, and/or epoxy resins. Use of more than one monomer may allow for control over thermal properties, mechanical behavior, the three-dimensional shape, microstructure of the polymer, and/or front velocity. The uncured liquid may further include one or more metathesis active catalysts, such as a ruthenium carbene, a tungsten carbene, a molybdenum carbene, or a vanadium carbene complex. For example, the catalyst may comprise a second generation Grubbs catalyst (GC2) or another ruthenium-based catalyst. The inhibitor may comprise a phosphite, phosphine, phosphoramidite, and/or nitrogen-containing heterocycle such as a pyridine or pyrrole. Specific examples of inhibitors may include trimethyl phosphite (TMP), triethyl phosphite (TEP), triisopropyl phosphite (TIPP), tributyl phosphite (TBP), triphenyl phosphite (TPP), and/or 4-dimethylaminopyridine (DMAPF). Each of the catalyst and inhibitor in the uncured liquid may be provided at a suitable concentration to control the polymerization reaction; for example, more catalyst can be added or the inhibitor concentration can be reduced to increase the propagation velocity and/or peak temperature of the polymerization front.

Typically, the triggering of the polymerization reaction comprises thermal or chemical triggering. The initiator, which is a solid, typically elongated object, may be heated resistively using an electric current. Accordingly, the initiator may be made in full or in part from an electrically conductive material. For example, the initiator may have a metallic surface and/or metallic components. The initiator may have the form of a soldering iron, resistive wire, or a cartridge heater, for example. To exploit chemical triggering, the initiator may be configured to hold or inject a small droplet of a catalytic liquid at the initiator tip to trigger the front. The catalytic liquid may comprise any of a number of catalysts and/or catalyst/monomer mixtures.

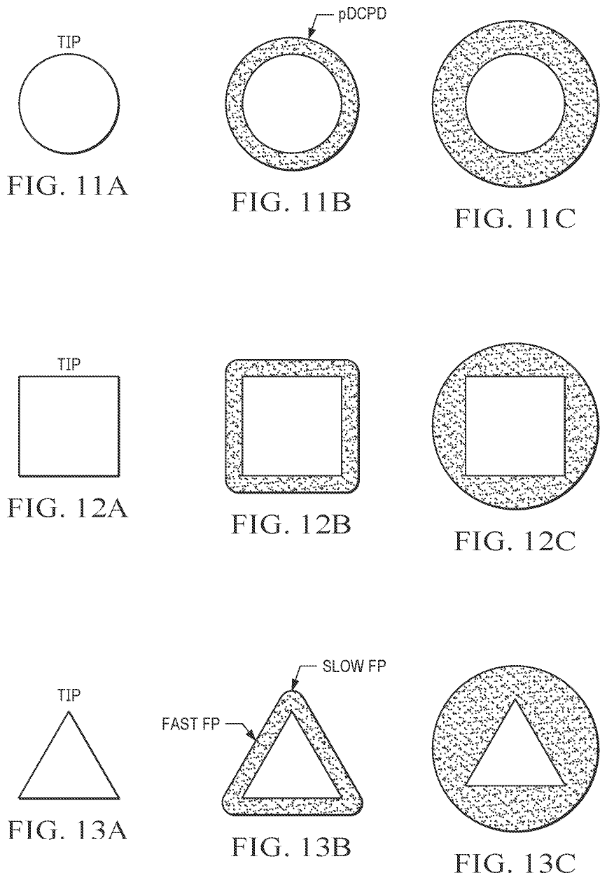

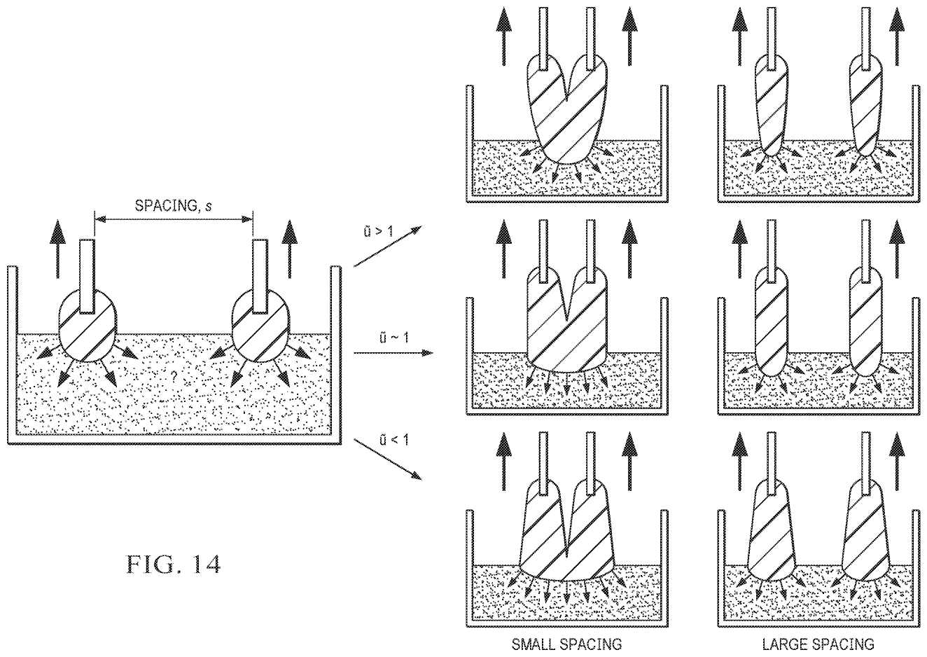

The initiator may have a cylindrical, conical, pyramidal, tetrahedral, rectangular prism, or another polyhedral geometry. The initiator has an end or tip that may be the origination point for the curing front. In some examples, the tip may be reduced in width or diameter compared to the rest of the initiator, forming an apex that may be beneficial for growth printing of 3D parts which readily detach from the initiator after printing. For example, the initiator may comprise a conical shape or an elongated cylindrical shape that terminates in an apex. The initiator may have a transverse cross-section shaped as a circle, an oval or ellipse, a square, a star, a heart or another curved or polygonal form. By controlling the transverse cross-section of the initiator, particularly at the tip, it may be possible to produce a curing front having a predetermined initial profile. If the initiator is a cylinder with a circular cross-section, for example, then the curing front may propagate initially with a circular profile. Upon moving the initiator vertically, the solid polymer may have a circular cross section and the final 3D part may resemble a sphere, cone or cylinder, for example, depending on the velocity control as described above. If the initiator is a rectangular prism having a square cross-section, then the curing front may propagate initially with a square profile. Upon moving the initiator vertically, the solid part may have a square cross section and the final 3D part may resemble a rectangular prism or cube. An initiator having a cross-section that is not axisymmetric may be used to produce a 3D part that is not axisymmetric. However, assuming the container holding the uncured liquid is large compared to the initiator tip and the produced part, the initial and final cross-sections of the 3D part may not be the same. For example, the part 3D being additively formed may initially have a cross-section (at the first (top) end to be produced) determined by the cross-section of the initiator, and may ultimately, as the initiator is moved and the 3D part gets longer, have a cross-section (at the second (bottom) end to be produced) approaching a circle. For example, for initiator tips having circular, square, and triangular cross-sections (FIGS. 11A, 12A and 13A, respectively), the resulting elongated 3D shapes may initially have a cross-section similar to that of the initiator tips (FIGS. 11B, 12B, and 13B) and ultimately, upon completion of growth printing, may have a circular or substantially circular cross section (FIGS. 11C, 12C, and 13C. This gradual cross section geometry change can be attributed to the fast curing front speed at flat slides of the triangle or square compared to the slower curing front speed at the corners of the shape. Hence, the sides become more circular because the curing front at the corners slow down.

In some examples, the initiator may have a hollow shape or include a nozzle, e.g., for delivery of a gas through the initiator, which may allow for additive fabrication of a hollow 3D part. Also or alternatively, a hollow initiator may be employed to form a stronger connection between the solid polymer and the initiator due to contact with both the inner and outer perimeter (e.g., inner and outer diameter) of the hollow initiator. In some examples, multiple initiators may be used, such as at least two, at least three, at least four, and/or up to ten initiators to generate multiple curing fronts simultaneously or sequentially. Complex and tunable part geometries can be produced by changing the number of initiators, the spacing between the initiators, the height offset of the initiator tips, the dwell time, degrees of freedom of movement of the initiators, and/or the velocity of the initiators. The multiple initiators may contact the uncured liquid in parallel, that is, utilizing the same motion control, or some or all of the initiators may have their own motion control. For example, multiple initiators may be connected to the same motion stage and manipulated in parallel and simultaneously. This controls the shape produced and can be used to form any desired cross section, such as a square or star shape, by using multiple initiators with a square- or star-like distribution in the uncured liquid. In another example, each initiator may have its own motion control, and the motion may be individually controlled to form 3D part(s) with complex shapes and cross sections. For instance, if two initiators are placed next to each other initially in the uncured liquid, and then are withdrawn at two different velocities with respect to the curing front velocity, the produced 3D part may have two different sides. In another example, if the first initiator activates the polymerization front and starts its upward trajectory, followed by the second initiator at a later time, the final 3D part may have different geometries along its length.

In another example, two initiators may be placed initially parallel to each other with a spacing S that may be large or small, as indicated in FIG. 14. Both initiator tips move vertically into and out of the container or vat holding the uncured liquid. First, the two initiators are heated to the same temperature, and then they are both moved downwards into the vat. The two initiator tips touch the uncured liquid at the same time. A polymerization front is initiated from each initiator while it is held in its static position. After a short duration, the curing fronts from the two initiators may merge and form one polymeric solid connected to the two initiators simultaneously. The two initiators are moved upwards at the same time at a certain velocity. In this example, the upward velocity is slightly larger than the front velocity, which produces a converging shape. Notably, the temperature of the liquid resin in between the two initiators within the vat increases due to the heat generated from the FROMP reaction. The higher temperature between the two initiators increase the velocity of the curing fronts anisotropically within the region between the two initiators. This accelerates the fronts within the region between the two initiators. The spacing between the two initiators, the initial dwell time, and the velocity ratio ũ may determine the final shape, as shown in FIG. 14.

As indicated above, if the initiator is not withdrawn from the uncured liquid, then frontal polymerization may ultimately lead to fabrication of a solid polymer having a shape defined by the container holding the uncured liquid. Containers having circular, elliptical, square, rectangular or other curved or polygonal cross sections may be employed. The shape or cross-section of the container may affect the temperature distribution around the curing front, which may in turn affect the velocity of the curing front. The container holding the uncured liquid may be placed in a temperature-controlled bath to ensure that the uncured resin stays at a desired temperature prior to exposure to the curing front. In some examples, one end of a tube may be placed in the container to continuously feed the uncured liquid at a desired rate so that the level of the uncured liquid remains constant in the container, even as a 3D part is being produced by growth printing. Hence depletion of the uncured liquid may be avoided. Using this approach, it may also or alternatively be possible to control the temperature of the uncured liquid and/or influence the curing front velocity, e.g., by feeding a stream of uncured liquid into the container at a controlled temperature. Multiple resin feed points may be used to further control the curing front velocity at various front locations. To ensure a uniform temperature distribution in the uncured liquid away from the curing front, the uncured liquid in the container may be stirred during growth printing.

To simulate the growth printing process, the coupled reaction-diffusion equations shown below, which describe the propagation speed, temperature, and direction of the curing front, may be solved numerically and used in two ways: (i) to predict the shape of a 3D part for a given motion of a heated initiator tip during growth printing (solving the “forward problem”), and/or (ii) to predict the motion of the heated initiator tip needed to print a predetermined or targeted shape of the 3D part (solving the “inverse problem”). The reaction-diffusion equations further include Heaviside functions, which provide a numerically efficient method to trim unnecessary computational regions, and updates the free surface of liquid resin with respect to the geometry of the produced part as the initiator is moving with respect to the free surface. The use of Heaviside function crops the calculation domain to the produced part and aligns the produced part geometry correctly with the free surface at any point in time. The numerical model also includes a fluid flow model to capture the impact of fluid convection taking place in the vat of liquid resin under rapid motion of the polymerized part as it is extracted from the liquid resin. The forward problem referred to above uses a fixed motion command, namely the velocity as function of time or position, to compute the shape of the produced part. The inverse problem referred to above generates the motion control commands required to produce a part of a predetermined geometry. The motion control commands describe the speed profile of the initiator, which then dictates the geometric profile of the produced part.

The coupled reaction-diffusion equations are:

$$ρ {C}_{p} \frac{\partial T}{\partial t} = κ {ℋ}_{AD} {∇}^{2} T - h ( T - {T}_{amb} ) / ∇ {ℋ}_{AD} / + ρ {H}_{r} \frac{\partial α}{\partial t} ,$$

$$\frac{\partial α}{\partial t} = A exp ( - \frac{E}{RT} ) {( 1 - α )}^{n} {ℋ}_{int} ,$$

where the temperature T and degree of cure α are the variables of interest. The first relation above models the heat diffusion with ρ, Cₚ, and κ respectively denoting the density, specific heat, and thermal conductivity of the resin, and Hᵣ is the heat generated by the exothermic reaction. The third term in that relation approximates the heat loss at the DCPD-air interface, with h denoting the heat transfer coefficient and T_{inf} the surrounding temperature. The second relation describes the cure kinetics of DCPD modeled in the form of an Arrhenius relation, with A, E, and R respectively denoting the time constant, activation energy, and ideal gas constant. The parameters A, E, and n are obtained through a nonlinear fitting of differential scanning calorimetry (DSC) data. The cure kinetics model can also be described by more detailed equations capturing the various steps of the FROMP reaction. The additional terms in the preceding equations correspond to Heavyside functions [symbol] ᵢₙₜ, [symbol] _{α}, [symbol] _{AD} used for tracking the air-liquid resin free surface, the reaction (curing) front, and the air-polymer (e.g., air-pDCPD) interface, respectively, and defined by

$${ℋ}_{int} = ℋ ( {z}_{int} ( t ) - z ) ,$$

$${ℋ}_{α} = ( α - {α}_{0} ) / ( 1 - {α}_{0} ) ,$$

$${ℋ}_{AD} = max ( {ℋ}_{α} , {ℋ}_{int} ) .$$

where zᵢₙₜ (t) is the vertical location of the free surface of the liquid resin, [symbol] (φ)=1/(1+exp (2.5φ/Δx)) is a smeared Heaviside function with Δx denoting the minimum grid size, and do is the initial degree of cure. The coupled reaction-diffusion equations are implemented in a nonlinear finite-element solver, taking advantage of its robust mesh adaptivity capability in order to capture the sharp, moving polymerization front.

Accordingly, the growth printing method may entail utilizing computer simulations to predict, based on the motion of the initiator, the shape of the 3D part additively formed by frontal polymerization (forward problem). Alternatively, the growth printing method may entail utilizing computer simulations to predict, based on a targeted shape, the motion of the initiator required to additively form the 3D part having the targeted shape by frontal polymerization. Utilizing computer simulations to predict the motion of the initiator may include a first step of representing the targeted shape mathematically in order to form a target curve. The reaction-diffusion equations presented above may be solved for degree of cure α and temperature T to determine an intersection point with the target curve at each time step, such that motion of a free surface of the uncured liquid may be determined. Based on the predicted motion of the free surface, G-code instructions may be provided to a motion stage operatively connected to the initiator (and/or operatively coupled to a container holding the uncured liquid). G-code, for geometry-code, is a programming language used for controlling automated tools and thus the term “G-code instructions” refers broadly to any type of coded instructions for prescribing the movement of the motion stage. As indicated above, the reaction-diffusion equations may include Heaviside functions tracking the horizontal air-liquid resin free surface, the reaction (curing) front, and the air-polymer interface. In some examples, the 3D part to be additively formed may be axisymmetric, and the target curve in this case may comprise a nonuniform rational B-spline curve, a mathematical model using basis splines that is suitable for representing curves and surfaces.

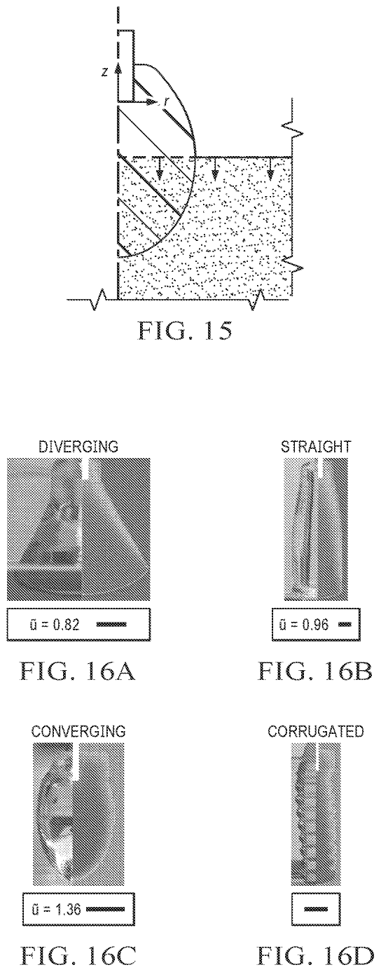

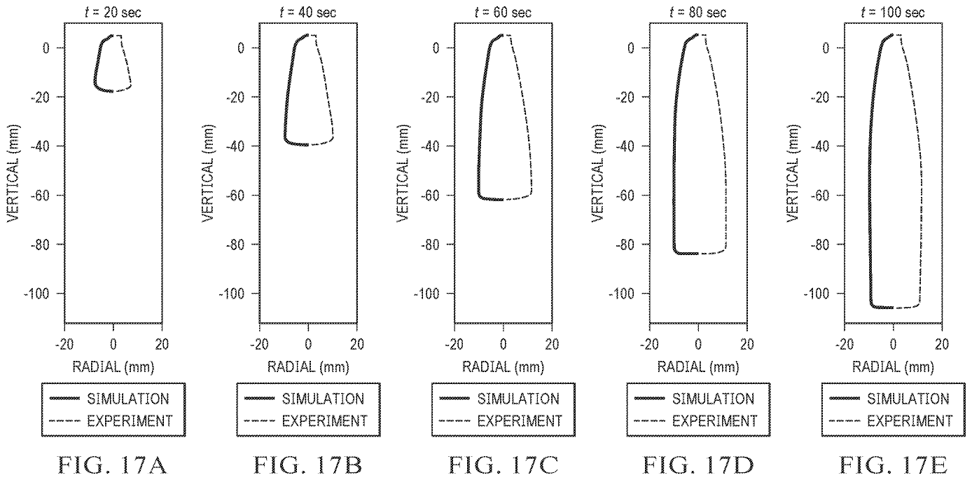

A schematic of the axisymmetric simulation problem is shown in FIG. 15. An axis system attached to the heated initiator tip is adopted, where the free surface of the uncured liquid is progressively raised or lowered to capture the relative motion of the initiator tip. A description of the initial and boundary conditions and additional details on the simulations can be found in the Examples section below. In solving the “inverse problem,” the axisymmetric targeted shape may be mathematically represented by a non-uniform rational B-spline (NURBS) curve. The location zᵢₙₜ of the resin free surface is obtained by extracting the intersection point (rᵢ, zᵢₙₜ) with the reaction front defined by the α=0.5 isocurve. Once they are found, rᵢ and zᵢₙₜ are transformed to zₜᵢₚ and the corresponding G-code. In FIGS. 16A-16D, the observed and computed shapes of printed parts are compared for different values of the velocity ratio ũ. As apparent there, the computational models successfully capture the main features of the growth printed 3D parts with divergent, straight (or vertical), convergent, and corrugated profiles, the last of which are obtained by adopting an intermittent upward motion of the tip. FIGS. 17A-17E presents a direct comparison between the observed and computed evolution of the shape of the printed part during growth printing.

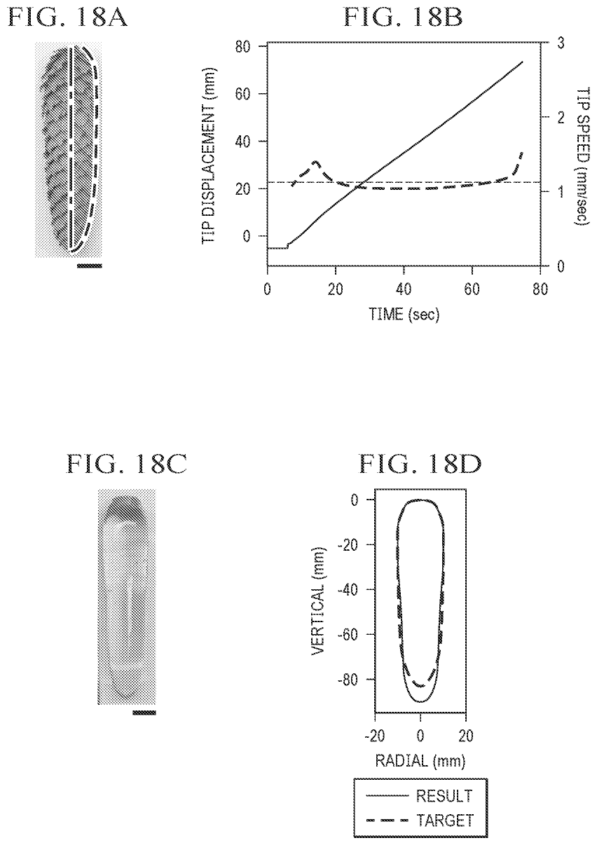

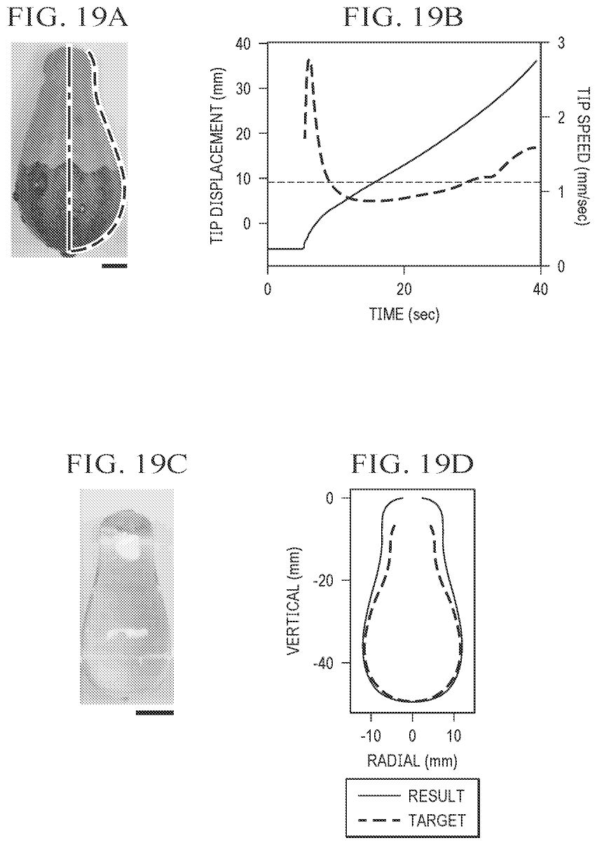

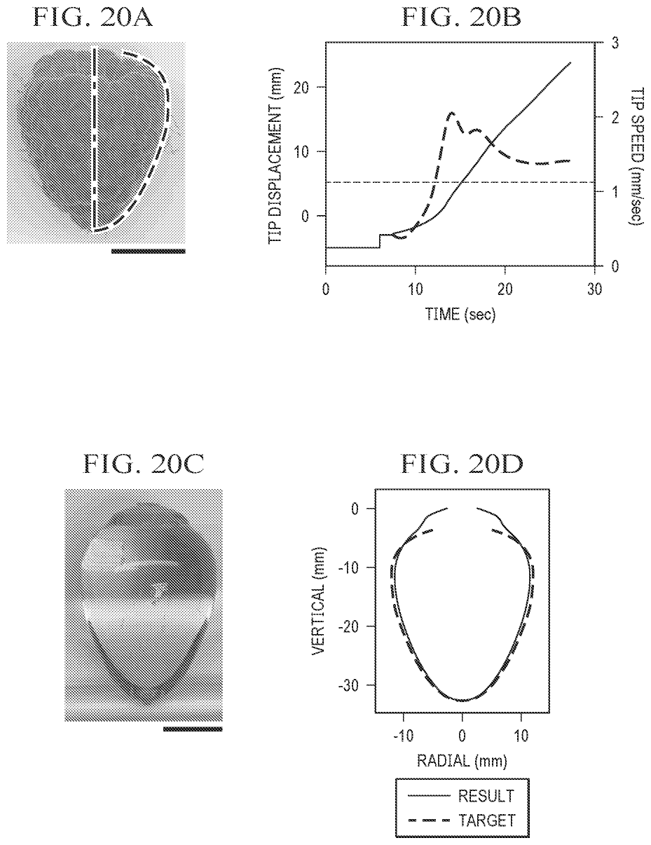

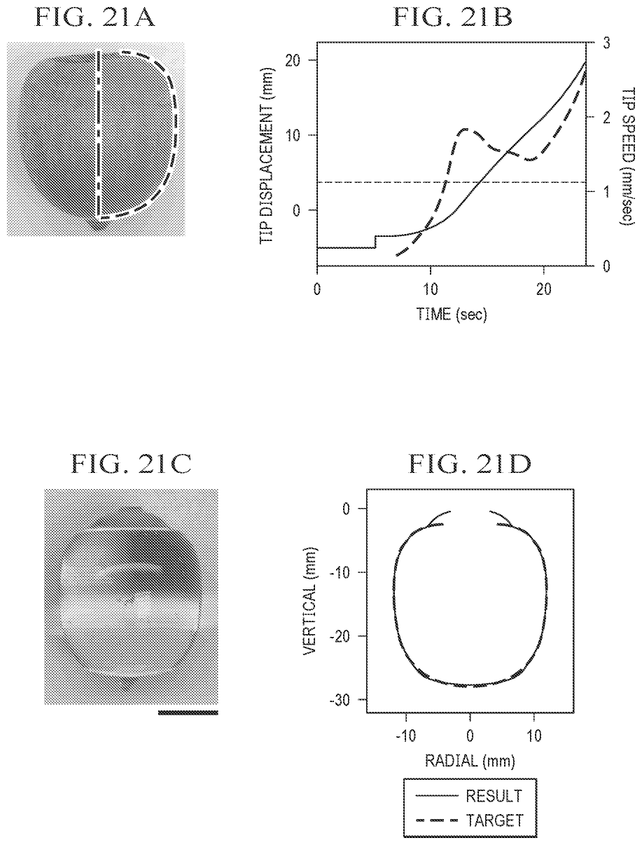

Four inverse problem examples utilizing natural objects (pinecone, mini pumpkin, raspberry, and acorn) to provide targeted shapes are presented in FIGS. 18-21. For each case, the figures show an image of the object and the associated NURBS curve (FIGS. 18A, 19A, 20A and 21A), the predicted motion (displacement and speed) of the heated initiator tip (FIGS. 18B, 19B, 20B, and 21B), an image of the actual printed part based on the G-code (FIGS. 18C, 19C, 20C, and 21C), and a comparison between the growth-printed part and the original target shapes (FIGS. 18D, 19D, 20D, and 21D). In the predicted tip motion plots, the dashed horizontal line refers to the steady-state zero-curvature front propagation velocity (ũ=1). As above, the printed shapes may be controlled by the velocity ratio ũ. The tip velocity in the case of the pine cone (FIGS. 18A and 18B) is almost constant, although the steady tip speed ũ is slightly lower than 1 due to the resin consumption and the curvature effect. In the mini-pumpkin case (FIGS. 19A and 19B), the velocity profile starts with ũ>>1 to capture the shape transition from a nearly spherical shape to a low curvature curve.

### Methods and Materials

### Resin Preparation

Dicyclopentadiene (DCPD) is solid at room temperature. Solid DCPD is heated to 50° C. to the liquid state and mixed with 5-Ethylidene-2-norbornene (ENB) in 95:5 wt % ratio. This mixture is liquid at room temperature. The mixed monomers are filtered through aluminum oxide powders to remove inhibitors present in the raw materials received from the manufacturer. In a typical growth-printing experiment, 60 mg of Grubb's catalyst M204 (GC2) are mixed to 3 ml phenylcyclohexane (PCH) and sonicated about 3 minutes. 19.1 μL tributhyl phosphate (TBP) are then added to the catalyst solution in a nitrogen glove box, and the prepared catalyst solution is added to 93.2 g DCPD/ENB. The final resin composition is GC2:DCPD/ENB:TBP:PCH=1 mg:1.553 g:0.319 μL:50 μL.

### Growth Printing Setup

Approximately 90 g of resin are poured into a 65×65×65 mm³ cubic glass beaker. The straight side walls of the beaker enable side-view optical photography. The resin bath is inserted into a larger 110×110×110 mm³ beaker filled with iced water to regulate the temperature of the resin bath during the experiments. The resin bath is maintained at 20±1° C. for growth printing. A cartridge heater of ⅛ inch diameter and 2-inch length (MCH2-80W-001, Comstat) is mounted to the motion stage (A3200, Aerotech). The cartridge heater is supplied 5 W of power and reaches approximately 100° C. before being dipped into the resin bath. The motion profile is programmed in G-code and executed to conduct the growth printing. A DSLR Camera (Canon EOS R5, Canon) is used to capture side-view videos.

Growth printing is enabled because a liquid monomer can be rapidly converted to a polymerized solid across a narrow (e.g., 0.5-2 mm) polymerization front. To capture this rapid phase transition, FROMP of an examplary resin (DPCD) was conducted on a parallel plate rheometer (DHR-3, TA Instruments), using disposable, 25 mm radius plates with a 1.7 mm gap. Peltier element heater was set to 90° C. to initiate a polymerization reaction of the resin between the plates and an oscillation stress of 100 Pa was applied at 10 Hz to measure the moduli.

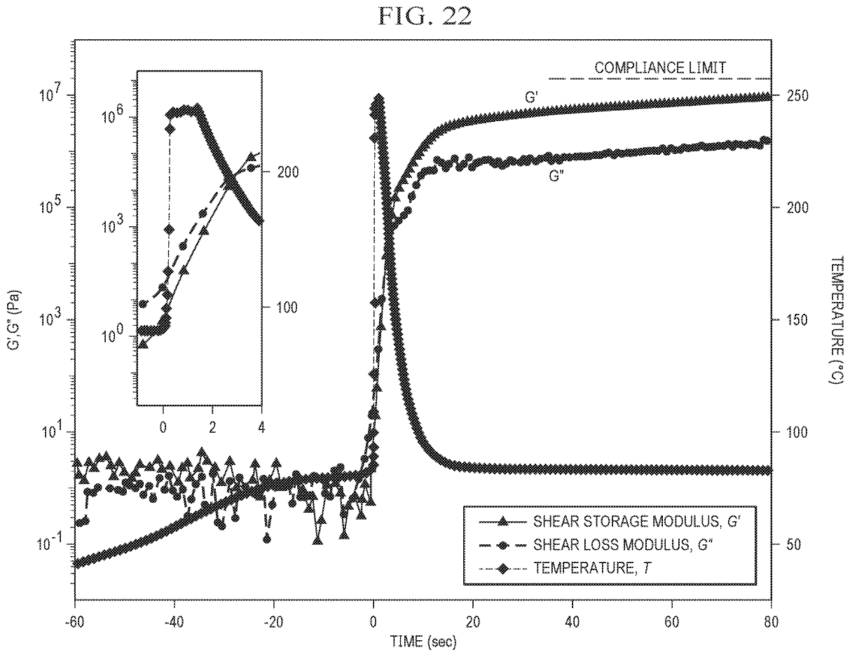

As shown in FIG. 22, a rapid increase in shear storage modulus is observed at the onset of the FROMP reaction. In this example, a four orders of magnitude increase in modulus occurs within four seconds in parallel with an increase in temperature up to 250° C. per second due to the highly exothermic FROMP reaction. After solidification, the polymerized resin (polyDCPD) has a storage modulus of around 108 Pa. The solid material soon cools down to around 90° C. due to heat diffusion to the plates.

### Governing Equations and Numerical Solution

The growth printing process can be captured by the coupled reaction-diffusion equations, as referred to above:

$$ρ {C}_{p} \frac{\partial T}{\partial t} = κ {ℋ}_{AD} {∇}^{2} T - h ( T - {T}_{amb} ) / ∇ {ℋ}_{AD} / + ρ {H}_{r} \frac{\partial α}{\partial t} ,$$

$$\frac{\partial α}{\partial t} = A exp ( - \frac{E}{RT} ) {( 1 - α )}^{n} {ℋ}_{int} ,$$

where the temperature T (K) and the non-dimensional degree of cure α are the variables of interest. The parameters entering the first (thermal diffusion) equation include the density ρ, specific heat Cₚ, thermal conductivity κ, heat transfer coefficient h, and reaction enthalpy Hᵣ. The second (chemical reaction) equation consists of a cure kinetics model involving an Arrhenius relation combined with the n^{th} order model (1−α)ⁿ. R represents the ideal gas constant, and the remaining parameters (pre-exponential factor A, activation energy E, and n) are given in a publication by Gao et al. The parameter h is introduced to reflect the heat loss across the DCPD-air interface and that by resin convection, with T_{amb} denoting the ambient temperature. Values of the physical constants are listed in Table 1.

TABLE 1
Physical constants used simulation

| Quantity | ρ | Cₚ | k | h | Hᵣ | R | A | E | n |
|---|---|---|---|---|---|---|---|---|---|
| Value | 980 | 1600 | 0.152 | 500 | 360000 | 8.314 | 15385e12 | 92799 | 2.3 |
| Unit | kg m⁻³ | J kg⁻¹ | W m⁻¹ | W m⁻² | J kg⁻¹ | J mol⁻¹ | s⁻¹ | J | — |
| | | K⁻¹ | K⁻¹ | K⁻¹ | | K⁻¹ | | mol⁻¹ | |

Finally, [symbol] ᵢₙₜ, [symbol] _{α}, and [symbol] AD are approximations of the Heaviside functions tracking the horizontal air-resin free surface, the reaction (curing) front, and the air-polymer (e.g., air-polyDCPD) interface, respectively, as defined above:

$${ℋ}_{int} = ℋ ( {z}_{int} ( t ) - z ) ,$$

$${ℋ}_{α} = ( α - {α}_{0} ) / ( 1 - {α}_{0} ) ,$$

$${ℋ}_{AD} = max ( {ℋ}_{α} , {ℋ}_{int} ) .$$

In the preceding equations, zᵢₙₜ (t) is the vertical location of the free surface of the liquid resin, [symbol] (φ)=1/(1+exp (2.5φ/Δx) is a smeared Heaviside function with Δx denoting the minimum grid size, and do is the initial degree of cure. In addition, the evolution of the interface location zᵢₙₜ (t) used in the simulation takes into consideration the conservation of resin volume through the following relation with the tip location zₜᵢₚ (t):

$$Δ {z}_{tip} ( t ) = - Δ {z}_{int} ( t ) ( 1 - {r}_{i}^{2} / {r}_{o}^{2} )$$

where Δz denotes an infinitesimal increment in the vertical direction, rᵢ is the radius of the polymer part at the free surface (defined as the r-coordinate of the intersection of the contour α(r, z, t)=0.5 with z=zᵢₙₜ (t)), and rₒ is the outer radius of the resin container.

The axisymmetric finite-element simulations based on the reaction-diffusion model are conducted using quadratic elements with the most refined element size Δxₘᵢₙ=0.025 mm. The transient simulations are performed with an implicit-Euler time integrator with a maximum time step size of 0.02 seconds. The initial conditions involve a temperature T₀=T_{amb}=293.15K and degree of cure α=0.01. The radius of the cartridge heater, modeled as a rectangular “cut-out” in the axisymmetric domain, is 1.6 mm, and the associated heating is modeled by the Neumann boundary condition ∇T·n=26,650 K/m, where n is the unit outward normal to the cartridge heater. All other boundaries are assumed to be adiabatic.

### Solution of Forward and Inverse Problems

In the forward problem, a time-dependent tip displacement is provided as the input to the numerical solver. As the reaction-diffusion problem is solved in a coordinate system attached to the cartridge heater, the motion of the heated tip is modeled by progressively lowering the interface location zᵢₙₜ (t) by an amount equal to the upward motion of the heater, i.e., zᵢₙₜ (t)=~zₜᵢₚ (t). To capture the fact that the resin surface drops as the resin is consumed during the printing process due to the finite volume of the resin vat, a correction is introduced, as indicated in the preceding equation.

The inverse problem starts from the target shape design as input. Due to the axisymmetric nature of the shape generated by the vertical motion of the heated tip, the target shape is simply described by a profile contour curve. Assuming that the target curve is parameterized by s∈[0, 1], the inverse problem including finding at every time step the value of s for which the boundary of the printed part (defined by the contour α=0.5) intersects the target curve. Denoting by (r*, z*) the location of that intersection at time t, the z-location of the resin surface is set at zᵢₙₜ(t)=z*.

The subject matter of this disclosure may also relate to the following aspects:

A first aspect relates to a growth printing method for manufacturing a three-dimensional (3D) part, comprising: triggering a frontal polymerization reaction by contacting an uncured liquid with an initiator; and after the frontal polymerization reaction is triggered, moving the initiator in at least one of x-, y- and z-directions to control a shape of a 3D part additively formed as the uncured liquid is polymerized.

A second aspect relates to the growth printing method of the first aspect, wherein, upon triggering the frontal polymerization reaction, a self-propagating curing front is generated in the uncured liquid, and, as the curing front propagates, the uncured liquid is polymerized.

A third aspect relates to the growth printing method of the first or second aspect, wherein the triggering comprises thermal or chemical triggering.

A fourth aspect relates to the growth printing method of any preceding aspect, wherein the triggering comprises supplying heat to the initiator until the initiator reaches a required temperature to initiate the frontal polymerization reaction.

A fifth aspect relates to the growth printing method of the preceding aspect, wherein the heat is supplied by an electric current.

A sixth aspect relates to the growth printing method of any preceding aspect, wherein, after the frontal polymerization reaction is triggered, no additional energy is input to the uncured polymer.

A seventh aspect relates to the growth printing method of any preceding aspect, wherein the initiator has an elongated solid geometry.

An eighth aspect relates to the growth printing method of any preceding aspect, wherein the initiator comprises a soldering iron, resistive wire, or a cartridge heater.

A ninth aspect relates to the growth printing method of any preceding aspect, wherein contacting the uncured liquid with the initiator comprises introducing the initiator into the uncured liquid, such that a tip of the initiator is at least 2 mm below a free surface of the uncured liquid.

A tenth aspect relates to the growth printing method of any preceding aspect, further comprising, after frontal polymerization is triggered and prior to moving the initiator, holding the initiator in the uncured liquid for a predetermined dwell time.

An eleventh aspect relates to the growth printing method of any preceding aspect, wherein the uncured liquid comprises an uncured polymer resin selected from the group consisting of dicyclopentadiene (DCPD), 1,5-cyclooctadiene (COD), benzocyclobutene, norbornene (NBE), 5-ethylidene-2-norbornene, NBE-acetate, and an epoxy resin.

A twelfth aspect relates to the growth printing method of any preceding aspect, wherein the uncured liquid further comprises a metathesis active catalyst selected from the group consisting of a ruthenium carbene complex, a tungsten carbene complex, a molybdenum carbene complex, and a vanadium carbene complex.

A thirteenth aspect relates to the growth printing method of any preceding aspect, wherein the uncured liquid further includes an inhibitor comprising a phosphite, phosphine, phosphoramidite, and/or nitrogen-containing heterocycle such as a pyridine or pyrrole.

A fourteenth aspect relates to the growth printing method of any preceding aspect, wherein the uncured liquid is provided in a container with an open top.

A fifteenth aspect relates to the growth printing method of any preceding aspect, wherein the self-propagating curing front remains below a level of a free surface of the uncured liquid during motion of the initiator.

A sixteenth aspect relates to the growth printing method of any preceding aspect, wherein the uncured liquid has a viscosity less than 1 Pas at room temperature (e.g., 18-23° C.).

A seventeenth aspect relates to the growth printing method of any preceding aspect, wherein the self-propagating curing front is drawn above a level of a free surface of the uncured liquid during motion of the initiator.

An eighteenth aspect relates to the growth printing method of any preceding aspect, wherein the uncured liquid has a high extensional viscosity of at least about 1 Pas at an extension rate imposed by the movement of the initiator at room temperature (e.g., 18-23° C.).

A nineteenth aspect relates to the growth printing method of any preceding aspect, wherein moving the initiator comprises withdrawing the initiator from the uncured liquid.

A twentieth aspect relates to the growth printing method of any preceding aspect, wherein, during the motion of the initiator, the 3D part being additively formed remains attached to the initiator.

A twenty-first aspect relates to the growth printing method of any preceding aspect, wherein moving the initiator further comprises tilting the initiator at an angle with respect to the z-direction and/or continuously rotating the initiator about one or more axes.

A twenty-second aspect relates to the growth printing method of any preceding aspect, further comprising modulating a velocity (uₜᵢₚ) of the initiator as the initiator moves.

A twenty-third aspect relates to the growth printing method of any preceding aspect, wherein the velocity (uₜᵢₚ) of the initiator is modulated to be higher than a velocity (u_{f}) of the curing front, such that a ratio uₜᵢₚ/u_{f} is greater than 1.

A twenty-fourth aspect relates to the growth printing method of any preceding aspect, wherein the shape of the 3D part converges as the initiator moves.

A twenty-fifth aspect relates to the growth printing method of any preceding aspect, wherein the velocity (uₜᵢₚ) of the initiator is modulated to be lower than a velocity (u_{f}) of the curing front, such that a ratio uₜᵢₚ/u_{f} is less than 1.

A twenty-sixth aspect relates to the growth printing method of any preceding aspect, wherein the shape of the 3D part diverges as the initiator moves.

A twenty-seventh aspect relates to the growth printing method of any preceding aspect, wherein the velocity (uₜᵢₚ) of the initiator is modulated to be about the same as a velocity (u_{f}) of the curing front, such that a ratio uₜᵢₚ/u_{f} is approximately equal to 1.

A twenty-seventh aspect relates to the growth printing method of any preceding aspect, wherein the shape of the 3D part is substantially straight.

A twenty-eighth aspect relates to the growth printing method of any preceding aspect, wherein a velocity (uₜᵢₚ) of the initiator is controlled to be higher than, lower than, and/or approximately the same as a velocity (u_{f}) of the curing front at different times during growth printing.

A twenty-ninth aspect relates to the growth printing method of any preceding claim, wherein the shape is axially symmetric.

A thirtieth aspect relates to the growth printing method of any preceding aspect, wherein the shape is not axially symmetric.

A thirty-first aspect relates to the growth printing method of any preceding aspect, wherein the shape is a sphere, a helix, a zigzag, a cone, an inverted cone, or a cylinder.

A thirty-second aspect relates to the growth printing method of any preceding aspect, wherein the shape includes one or more surface corrugations.

A thirty-third aspect relates to the growth printing method of any preceding aspect, wherein the initiator has a cylindrical, conical, pyramidal, tetrahedral, rectangular prism, or other polyhedral geometry.

A thirty-fourth aspect relates to the growth printing method of any preceding aspect, wherein a transverse cross-section of the initiator is shaped as a circle, an oval, an ellipse, a square, a star, or a heart.

A thirty-fifth aspect relates to the growth printing method of any preceding aspect, wherein the initiator has a hollow shape or includes a nozzle for delivery of gas therethrough.

A thirty-sixth aspect relates to the growth printing method of any preceding aspect, further comprising: applying a gas stream or gas pressure to a center of the shape as the initiator is moved, such that the shape is hollow.

A thirty-seventh aspect relates to the growth printing method of any preceding aspect, wherein at least two initiators are used to contact the uncured liquid.

A thirty-eighth aspect relates to the growth printing method of any preceding aspect, wherein at least two self-propagating curing fronts are generated in the uncured liquid simultaneously or sequentially.

A fortieth aspect relates to the growth printing method of any preceding aspect, wherein the at least two initiators contact the uncured liquid in parallel, the at least two initiators sharing one motion control.

A forty-first aspect relates to the growth printing method of any preceding aspect, wherein the at least two initiators contact the uncured liquid independently, each initiator having a separate motion control.

A forty-second aspect relates to the growth printing method of any preceding aspect, further comprising: utilizing computer simulations to predict, based on the motion of the initiator, the shape of the 3D part additively formed during frontal polymerization.

A forty-third aspect relates to the growth printing method of any preceding aspect, further comprising: wherein the shape is a predetermined shape; and utilizing computer simulations to predict the motion of the initiator required to additively form the 3D part in the predetermined shape during frontal polymerization.

A forty-fourth aspect relates to the growth printing method of any preceding aspect, wherein utilizing computer simulations to predict the motion of the initiator comprises: representing the predetermined shape mathematically, thereby forming a target curve; solving reaction-diffusion equations including for degree of cure α and temperature T to determine an intersection point with the target curve at each time step, thereby determining motion of a free surface of the uncured liquid; and based on the motion of the free surface, providing G-code instructions to a motion stage operatively connected to the initiator.

A forty-fifth aspect relates to the growth printing method of any preceding aspect, wherein the reaction-diffusion equations include Heaviside functions tracking a horizontal air-resin free surface, a reaction front, and an air-polymer interface.

A forty-sixth aspect relates to the growth printing method of any preceding aspect, wherein the 3D part to be additively formed is axisymmetric, and wherein the target curve is a nonuniform rational B-spline curve.

A forty-seventh aspect relates to a growth printing method for manufacturing a three-dimensional (3D) part, the method comprising: providing a container having an uncured liquid resin, the container having an open top; positioning an initiator above the open top of the container; lowering the initiator into the uncured liquid resin, thereby triggering a frontal polymerization reaction; and after a predetermined dwelling time, spatially moving the initiator in at least one of x-, y- and z-directions at a predetermined speed in order to additively produce a desired shape of a 3D part as the uncured liquid resin is polymerized.

A forty-eighth aspect relates to the growth printing method of any preceding aspect, wherein the desired shape is convergent and the predetermined speed is faster than a curing front speed to produce the desired shape, and/or wherein the desired shape is an inverted cone having a top base, and the predetermined speed is faster than a curing front speed to produce the desired shape.

A forty-ninth aspect relates to the growth printing method of any preceding aspect, wherein the desired shape is divergent and the predetermined speed is slower than the curing front speed to produce the desired shape, and/or wherein the desired shape is a cone with a bottom base and the predetermined speed is slower than the curing front speed to produce the desired shape.

A fiftieth aspect relates to the growth printing method of any preceding aspect, wherein the desired shape is cylindrical and the predetermined speed substantially matches the curing front speed.

A fifty-first aspect relates to the growth printing method of any preceding aspect, wherein the desired shape is cylindrical or conical with corrugations on a surface thereof, and the predetermined speed is modulated to produce the desired shape.

A fifty-second aspect relates to the growth printing method of any preceding aspect, wherein the desired shape is a helical or a zigzag shaped part, and the initiator is tilted and/or continuously rotated about one or more axes to produce the desired shape.

A fifty-third aspect relates to the growth printing method of any preceding aspect, wherein the predetermined speed is modulated to obtain the desired shape; and/or wherein the initiator is moved in more than one direction or in all three directions to produce the desired shape.

A fifty-forth aspect relates to the growth printing method of any preceding aspect, wherein the initiator is positioned above the open top (e.g., at least 5 mm above) before it contacts the uncured liquid resin to initiate the frontal polymerization reaction.

A fifty-fifth aspect relates to the growth printing method of any preceding aspect, wherein the initiator has an elongated cylindrical geometry with a metallic surface and/or a soldering iron tip.

A fifty-sixth aspect relates to the growth printing method of any preceding aspect, wherein the triggering comprises supplying heat to the initiator until the initiator reaches a required temperature for initiating the frontal polymerization reaction.

A fifty-seventh aspect relates to the growth printing method of any preceding aspect, wherein the heat is supplied by an electric current.

A fifty-eighth aspect relates to the growth printing method of any preceding aspect, wherein the initiator is lowered such that a tip of the initiator is at least 2 mm below a surface of the uncured liquid resin.

A fifty-ninth aspect relates a growth printing method for manufacturing a three-dimensional (3D) part, comprising: utilizing computer simulations to predict the motion of an initiator required to additively form via frontal polymerization a 3D part having a targeted shape; contacting an uncured liquid with the initiator to trigger a frontal polymerization reaction; and after the frontal polymerization reaction is triggered, moving the initiator as predicted by the computer simulations to additively form the 3D part having the targeted shape as the uncured liquid is polymerized.

A sixtieth aspect relates to the growth printing method of any preceding aspect, wherein utilizing computer simulations to predict the motion of the initiator comprises: representing the targeted shape mathematically, thereby forming a target curve; solving reaction-diffusion equations including for degree of cure α and temperature T to determine an intersection point with the target curve at each time step, thereby determining motion of a free surface of the uncured liquid; and based on the motion of the free surface, providing G-code instructions to a motion stage operatively connected to the initiator.

A sixty-first aspect relates to the growth printing method of any preceding aspect, wherein the reaction-diffusion equations include Heaviside functions tracking a horizontal air-resin free surface, a reaction front, and an air-polymer interface.

A sixth-second aspect relates to the growth printing method of any preceding aspect, wherein the 3D part to be additively formed is axisymmetric, and wherein the target curve is a nonuniform rational B-spline curve.

A sixty-third aspect relates to the growth printing method of any preceding aspect, wherein a camera is positioned to observe the frontal polymerization reaction, and further comprising providing a feedback signal to the computer simulation based on data collected by the camera.

The present invention has been described in connection with what are presently considered to be the most practical and preferred embodiments. However, the invention has been presented by way of illustration and is not intended to be limited to the disclosed embodiments. Accordingly, one of skill in the art will realize that the invention is intended to encompass all modifications and alternative arrangements within the spirit and scope of the invention as set forth in the appended claims.

1. A growth printing method for manufacturing a three-dimensional (3D) part, the method comprising:
triggering a frontal polymerization reaction by contacting an uncured liquid with an initiator;
after the frontal polymerization reaction is triggered, moving the initiator in at least one of x-, y- and z-directions to control a shape of a 3D part additively formed as the uncured liquid is polymerized.

2-5. (canceled)

6. The growth printing method of claim 1, wherein, after the frontal polymerization reaction is triggered, no additional energy is input to the uncured polymer.

7-18. (canceled)

19. The growth printing method of claim 1, wherein moving the initiator comprises withdrawing the initiator from the uncured liquid.

20. The growth printing method of claim 1, wherein, during the motion of the initiator, the 3D part being additively formed remains attached to the initiator.

21. The growth printing method of claim 1, wherein moving the initiator further comprises tilting the initiator at an angle with respect to the z-direction and/or continuously rotating the initiator about one or more axes.

22. The growth printing method of claim 1, further comprising modulating a velocity (uₜᵢₚ) of the initiator as the initiator moves.

23. The growth printing method of claim 22, wherein the velocity (uₜᵢₚ) of the initiator is modulated to be higher than a velocity (u_{f}) of the curing front, such that a ratio uₜᵢₚ/u_{f} is greater than 1.

24. The growth printing method of claim 23, wherein the shape of the 3D part converges as the initiator moves.

25. The growth printing method of claim 22, wherein the velocity (uₜᵢₚ) of the initiator is modulated to be lower than a velocity (u_{f}) of the curing front, such that a ratio uₜᵢₚ/u_{f} is less than 1.

26. The growth printing method of claim 25, wherein the shape of the 3D part diverges as the initiator moves.

27-42. (canceled)

43. The growth printing method of claim 1, further comprising:
wherein the shape is a predetermined shape; and
utilizing computer simulations to predict the motion of the initiator required to additively form the 3D part having the predetermined shape during frontal polymerization.

44. The growth printing method of claim 43, wherein utilizing computer simulations to predict the motion of the initiator comprises:
representing the predetermined shape mathematically, thereby forming a target curve;
solving reaction-diffusion equations including for degree of cure α and temperature T to determine an intersection point with the target curve at each time step, thereby determining motion of a free surface of the uncured liquid; and
based on the motion of the free surface, providing G-code instructions to a motion stage operatively connected to the initiator.

45-46. (canceled)

47. A growth printing method for manufacturing a three-dimensional (3D) part, the method comprising:
providing a container having an uncured liquid resin, the container having an open top;
positioning an initiator above the open top of the container;
lowering the initiator into the uncured liquid resin, thereby triggering a frontal polymerization reaction; and
after a predetermined dwelling time, spatially moving the initiator in at least one of x-, y- and z-directions at a predetermined speed in order to additively produce a desired shape of a 3D part as the uncured liquid resin is polymerized.

48. The growth printing method of claim 47, wherein the desired shape is convergent and the predetermined speed is faster than a curing front speed to produce the desired shape, and/or
wherein the desired shape is an inverted cone having a top base, and the predetermined speed is faster than a curing front speed to produce the desired shape.

49. The growth printing method of claim 47, wherein the desired shape is divergent and the predetermined speed is slower than the curing front speed to produce the desired shape, and/or
wherein the desired shape is a cone with a bottom base and the predetermined speed is slower than the curing front speed to produce the desired shape.

50-58. (canceled)

59. A growth printing method for manufacturing a three-dimensional (3D) part, the method comprising:
utilizing computer simulations to predict the motion of an initiator required to additively form a 3D part having a targeted shape during frontal polymerization;
contacting an uncured liquid with the initiator to trigger a frontal polymerization reaction; and
after the frontal polymerization reaction is triggered, moving the initiator as predicted by the computer simulations to additively form, as the uncured liquid is polymerized, the 3D part having the targeted shape.

60. The growth printing method of claim 59, wherein utilizing computer simulations to predict the motion of the initiator comprises:
representing the targeted shape mathematically, thereby forming a target curve;
solving reaction-diffusion equations including for degree of cure α and temperature T to determine an intersection point with the target curve at each time step, thereby determining motion of a free surface of the uncured liquid; and
based on the motion of the free surface, providing G-code instructions to a motion stage operatively connected to the initiator.

61. The growth printing method of claim 60, wherein the reaction-diffusion equations include Heaviside functions tracking a horizontal air-resin free surface, a reaction front, and an air-polymer interface.

62. The growth printing method of claim 60, wherein the 3D part to be additively formed is axisymmetric, and wherein the target curve is a nonuniform rational B-spline curve.

63. The growth printing method of claim 59, wherein a camera is positioned to observe the frontal polymerization reaction, and further comprising providing a feedback signal to the computer simulation based on data collected by the camera.
